(19) United States
(12) Patent Application Publication
(10) Pub. No.: US 2023/0362017 A1
(43) Pub. Date: Nov. 9, 2023

(54) CRYPTOGRAPHIC INVENTORY SYSTEM

(71) Applicant: Snowball Growth Capital LLC, Boulder, CO (US)

(72) Inventors: David E. Fitzjarrell, Colorado Springs, CO (US); Serhii Halkin, Colorado Springs, CO (US); Cameron D. Williams, Littleton, CO (US)

(73) Assignee: Snowball Growth Capital LLC, Boulder, CO (US)

(21) Appl. No.: 18/314,634

(22) Filed: May 9, 2023

Related U.S. Application Data
(60) Provisional application No. 63/339,917, filed on May 9, 2022.

(51) Int. Cl. H04L 9/32

(52) U.S. Cl. CPC H04L 9/3263

(57) ABSTRACT

Systems and methods for creating and making use of a cryptographic inventory are provided. According to one embodiment, cryptographic resources are discovered within one or more of a private datacenter, a colocation facility, and a public cloud. The cryptographic resources include assets and respective cryptographic material used by the assets. Respective relationships among the cryptographic resources are determined or inferred. Based on the cryptographic resources and the respective relationships, a cryptographic inventory is created or updated in a form of a semantic network that may be used to facilitate cryptoperiod reduction by enabling automated performance of a cryptographic action involving multiple of the cryptographic resources in which nodes of the semantic network represent the cryptographic resources and edges of the semantic network represent the respective relationships.

### CROSS-REFERENCE TO RELATED PATENTS

This application claims the benefit of priority of U.S. Provisional Application No. 63/339,917, filed on May 9, 2022, which is hereby incorporated by reference in its entirety for all purposes.

### BACKGROUND

### Field

Various embodiments of the present disclosure generally relate to security of information technology (IT) infrastructure, data, applications, services, and cryptographic materials (e.g., cryptographic keys, cryptographic certificates, etc.), and management of cryptographic materials. In particular, some embodiments relate to an automated approach for creating a high-fidelity cryptographic inventory by, among other things, discovering cryptographic materials and assets within at least one target environment (e.g., all cryptographic materials and assets of an enterprise including one or more public clouds (multi-cloud) and on-premise network(s)) and classifying the discovered cryptographic materials based on their respective usage within the target environment(s).

### Description of the Related Art

A cryptographic key (which represents a non-limiting example of cryptographic material) is a parameter used in conjunction with a cryptographic algorithm that determines the specific operation of that algorithm. Cryptographic algorithms are commonly used to ensure (e.g., via data encryption, and/or via digital signature) information is kept private and secure from unintended parties, or in the case of a digital signature ensure authenticity and integrity of a digital document, message or software. Depending upon the algorithms employed and the security requirements, cryptographic systems may use different types and lengths of cryptographic keys, with some systems using more than one cryptographic key. For example, a database may use a digital certificate (e.g., a Transport Layer Security (TLS) certificate) to secure communications, a cryptographic key for encrypting tables as a whole, and a separate key for encrypting individual cells (e.g., payment card industry (PCI) data). In cryptography, a public key certificate, also known as a digital certificate or identity certificate, is an electronic document used to prove the validity of a public key. Cryptographic certificates are widely used to prove the identity of corresponding private key owner (computer or human).

In view of regulatory compliance standards and highly publicized data losses, the use of cryptographic materials are on the rise across enterprises of all types. A single enterprise may deploy cryptographic materials at many different levels, for many different channels, and across a number of different environments (e.g., including, for example, as part of securing websites, email communications, user data, enterprise data, customer data, and the like). As a result, a medium to large enterprise might be faced with dealing with potentially thousands of cryptographic materials at any given time.

### SUMMARY

Systems and methods are described for creating and making use of a cryptographic inventory. According to one embodiment, cryptographic resources are discovered within one or more of a private datacenter, a colocation facility, and a public cloud. The cryptographic resources include assets and respective cryptographic material used by the assets. Respective relationships among the cryptographic resources are determined or inferred. Based on the cryptographic resources and the respective relationships, a cryptographic inventory is created or updated in a form of a semantic network that may be used to facilitate cryptoperiod reduction by enabling automated performance of a cryptographic action involving multiple of the cryptographic resources in which nodes of the semantic network represent the cryptographic resources and edges of the semantic network represent the respective relationships.

According to another embodiment, a cryptographic inventory is created or updated by discovering assets and respective cryptographic material used by each of the assets. The cryptographic inventory includes a mapping between the assets and the respective cryptographic material. A security risk is identified based on the cryptographic inventory. The security risk is then mitigated by performing a cryptographic action based on the cryptographic inventory.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a block diagram conceptually illustrating inventory maintenance and access in accordance with an embodiment of the present disclosure.

FIG. 2A is a block diagram illustrating a Software-as-a-Service (SaaS) delivery model in accordance with an embodiment of the present disclosure.

FIG. 2B illustrates an example of discovered cryptographic material.

FIG. 2C illustrates an example of a cryptographic material item data structure that may be populated for discovered cryptographic material in accordance with an embodiment of the present disclosure.

FIG. 3 is a block diagram illustrating a command post portal and a command post server in accordance with an embodiment of the present disclosure.

FIG. 4A is a block diagram illustrating example agent interactions with infrastructure of a target environment to discover cryptographic material and associated assets within the target environment in accordance with an embodiment of the present disclosure.

FIG. 4B illustrates an example of discovered asset information.

FIG. 4C illustrates an example of an asset item data structure that may be populated for each discovered asset in accordance with an embodiment of the present disclosure.

FIG. 5 is a flow diagram illustrating a set of operations for performing a process to discover cryptographic materials associated with a target environment in accordance with an embodiment of the present disclosure.

FIG. 6 is a flow diagram illustrating a set of operations for performing a file system crawling process in accordance with an embodiment of the present disclosure.

FIG. 7 is a flow diagram illustrating a set of operations for mitigation of a security risk in accordance with an embodiment of the present disclosure.

FIG. 8 is a flow diagram illustrating a set of operations for creating/updating a cryptographic inventory in accordance with an embodiment of the present disclosure.

FIG. 9 is a flow diagram illustrating a set of operations for performing database discovery in accordance with an embodiment of the present disclosure.

FIG. 10 is a flow diagram illustrating a set of operations for deploying an agent within a target environment in accordance with an embodiment of the present disclosure.

FIG. 11 is a flow diagram illustrating a set of operations for performing a key roll in accordance with an embodiment of the present disclosure.

FIG. 12 is a flow diagram illustrating a set of operations for performing a pre-check and/or a post-check in accordance with an embodiment of the present disclosure.

FIG. 13 is a flow diagram illustrating a set of operations for performing a cryptographic material exchange in accordance with an embodiment of the present disclosure.

FIG. 14 illustrates an example computer system in which or with which embodiments of the present disclosure may be utilized.

FIG. 15 is a flow diagram illustrating operations for identifying security risks in accordance with an embodiment of the present disclosure.

FIG. 16 is a flow diagram illustrating operations for automating mitigation actions to resolve security risks while minimizing human interaction in accordance with an embodiment of the present disclosure.

FIG. 17 is a knowledge graph diagram illustrating the use of data from cryptographic inventory database to determine security risks and/or to facilitate automated mitigation of security risks in accordance with an embodiment of the present disclosure.

### DETAILED DESCRIPTION

Systems and methods are described for creating and making use of a cryptographic inventory. At present, the collection of cryptographic materials and information regarding the purpose of cryptographic materials within a target environment involves a time-consuming and inherently error prone approach in which highly skilled individuals perform manual operations. Due at least in part to the time intensive and costly nature of gathering information regarding cryptographic materials, this manual process is typically performed only when required, for example, a part of an investigation into a suspected data breach.

During an incident response phase of a data breach, a key roll (e.g., a rotation or changing of cryptographic material) may be performed to preclude the use of compromised cryptographic keys. A key roll may require a large amount of information regarding the nature and use of cryptography within a target environment (e.g., internal systems, computers, and the like). As such, prior to performing an actual roll operation, members of an internal or external incident response team may manually utilize one or more point solutions or tools to research user flows of all internal systems searching for the use of a particular compromised cryptographic key. Once identified, a key roll may be scheduled. Unfortunately, due to the existence of shadow inventory (e.g., representing those cryptographic resources of a target environment that are not identified by or otherwise overlooked by manual approaches), only after the key roll occurs are all systems affected by the key roll identified—typically, as a result of unintended effects of the key roll on systems whose use of an encrypted resource was not previously known.

In view of the foregoing, embodiments described herein seek to provide an automated approach for performing intelligence gathering regarding cryptographic resources, including creating a cryptographic inventory for one or more target environments. For example, a combination of external and internal methods may be used to collect existing cryptographic materials (e.g., keys, certificates, and the like) and information regarding assets that use or are used by these cryptographic materials that reside within the target environment(s). The collected information may then be enriched to create a mapping (e.g., represented within or in the form of a cryptographic inventory) between each particular asset and the cryptographic material the particular asset is using or is used by. This enriched data set increases confidence in and facilitates the use of cryptographic actions to mitigate security risks, either manually or automatically. In some embodiments, the high-fidelity nature, increased accuracy, and efficient representation of the cryptographic inventory enable automated key rotation to be performed by or on behalf of an enterprise at a high cadence, thereby facilitating a reduction of the cryptoperiod to that which is shorter than a period of time in which the encryption can be feasibly broken via a security exploit (e.g., compromising a key via a side-channel attack).

As described further below, the automated approach may be controlled via a portal of a SaaS platform and may involve the use of a combination of external and internal methods to discover cryptographic materials from outside of the target environment and from within the target environment. For example, in one embodiment, an automated cryptographic key inventory creation process includes commands issued by a server to discover multiple remote hosts within the target environment. For a given host of the multiple hosts, information may be collected regarding cryptographic material residing on the given host and an asset associated with the given host that uses the cryptographic material by causing a file system crawling process to be performed on the given host. The server may then facilitate creation of a mapping between multiple assets within the target environment and respective cryptographic material used by the multiple assets by providing the server with the collected information.

In another embodiment, an automated cryptographic key inventory creation process may involve the use of a reconnaissance agent. For example, an external server may deploy the agent within a target environment. Responsive to discovery commands issued by the server, the agent may discover multiple remote hosts within the target environment. For a given host of the multiple hosts, the agent may collect information regarding cryptographic material residing on the given host and an asset associated with the given host that uses the cryptographic material by causing a file system crawling process to be performed on the given host. The agent may then facilitate creation by the server of a mapping between multiple assets within the target environment and respective cryptographic material used by the multiple assets by providing the server with the collected information.

While in the context of various embodiments described herein a reconnaissance agent may be used to perform various internal methods, in alternative embodiments, it is to be appreciated an agentless approach may be used. Additionally, while various examples are described with respect to a file system mounted on an operating system, it is to be appreciated the methodologies described here are also applicable to file systems, such as Network File System (NFS), Common Internet File System (CIFS), Server message Block (SMB) that facilitate accessing files stored on storage devices distributed throughout a network, as well as Web 3.0, the next evolution of the World Wide Web.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

A “computer” or “computer system” may be one or more physical computers, virtual computers, or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to “a computer” or “a computer system” herein may mean one or more computers, unless expressly stated otherwise.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used herein, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein a “cloud” or “cloud environment” broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a cloud provider (e.g., a business, academic, or government organization, or some combination of them), and exists on the premises of the cloud provider. The cloud service provider may offer a cloud-based platform, infrastructure, application, or storage services as-a-service, in accordance with a number of service models, including Software-as-a-Service (SaaS), Platform-as-a-Service (PaaS), and/or Infrastructure-as-a-Service (IaaS). In the hybrid cloud deployment model, the cloud infrastructure is a composition of two or more distinct cloud infrastructures (private, community, or public) that remain unique entities, but are bound together by standardized or proprietary technology that enables data and application portability (e.g., cloud bursting for load balancing between clouds).

As used herein a “cryptographic asset” or simply an “asset” generally refers to any object that can be encrypted, make use of encryption, provides at least one cryptographic function, or manages or provisions cryptographic material or both. Non-limiting examples of assets include a computer file, computer hardware, IT infrastructure, a hardware security module, public cloud resources, applications, data sets, database management systems, computer systems, operating system hosts, or services, for example, a key management service, object storage service, or a managed relational or non-relational database service (e.g., Amazon Web Services (AWS) Relational Database Service (RDS)) configured or in use within a target environment.

As used herein “cryptographic inventory information” generally refers to information regarding assets and cryptographic materials (e.g., cryptographic keys, digital certificates, and the like). The cryptographic materials and/or assets (which may be collectively referred to herein as cryptographic resources) may be discovered within at least one target environment, for example, a private datacenter, a colocation facility, and/or one or more cloud service providers. Cryptographic inventory information may be discovered, determined, observed, or inferred (e.g., via correlation). Non-limiting examples of cryptographic inventory information includes information regarding relationships among the assets, the cryptographic materials, and/or each other, information regarding assets that can make use of cryptographic materials, classification (e.g., identifying a common application name) of network ports or protocols or both (e.g., handlers) of assets, classification (e.g., which may be assigned at least one identifier to designate a relationship between assets) of inter-communication where two or more assets are discovered to be communicating with each other. For example, two assets may be determined to be in communication with each other when an asset, which is not contained within the target asset, is identified through various methods of discovery on a target asset. The relationship between a given pair of assets may also include information regarding a role of each asset, for example, as a data presenter or as a data consumer. As described further below, in one embodiment, the cryptographic inventory information may be stored in a cryptographic inventory database represented in the form of a knowledge graph or a semantic network.

As used herein “cryptographic inventory facts” or simply “facts” generally refer to information or data that is derived or created based at least in part on cryptographic inventory information. For example, the time and location of a key roll, combined with the result of the key roll is a fact that may be subsequently used in connection with determining whether a particular security risk exists or whether a mitigation effort was successful. Cryptographic inventory facts may be discovered, determined, observed, or inferred (e.g., via correlation). Non-limiting examples of cryptographic inventory facts include the cryptoperiod of a particular asset's use of a particular cryptographic material, the classification of a listener on particular network port in use by a particular asset, number of connected assets to a particular asset, cryptographic material in use by assets that are connected to a particular asset.

As used herein a “security risk” generally refers to the existence of a fact, event, or condition that is indicative of a potential for compromise of confidentiality, integrity, and/or availability of an asset or cryptographic material. Non-limiting examples of security risks include key reuse, cryptographic material expiration, cryptographic erase, potential cryptographic erase, malformed Key Management System (KMS) or Hardware Security Module (HSM) key, key compromise, stale systems, Indicator of Attack (IOA), Indicator of Compromise (IOC), orphan cryptographic material, and the like.

A “cryptographic action” generally refers to changes that directly or indirectly affect the use of a cryptographic material by a particular asset. Non-limiting examples of cryptographic actions include key roll, cryptographic material exchange, adding use of cryptographic material where it was not used previously.

As used herein “key roll” generally refers to a rotation or changing of existing cryptographic material for all assets that make use of cryptography through particular cryptographic material, or introduction of a new use of cryptography for one or more assets that were not previously in use.

### Overview

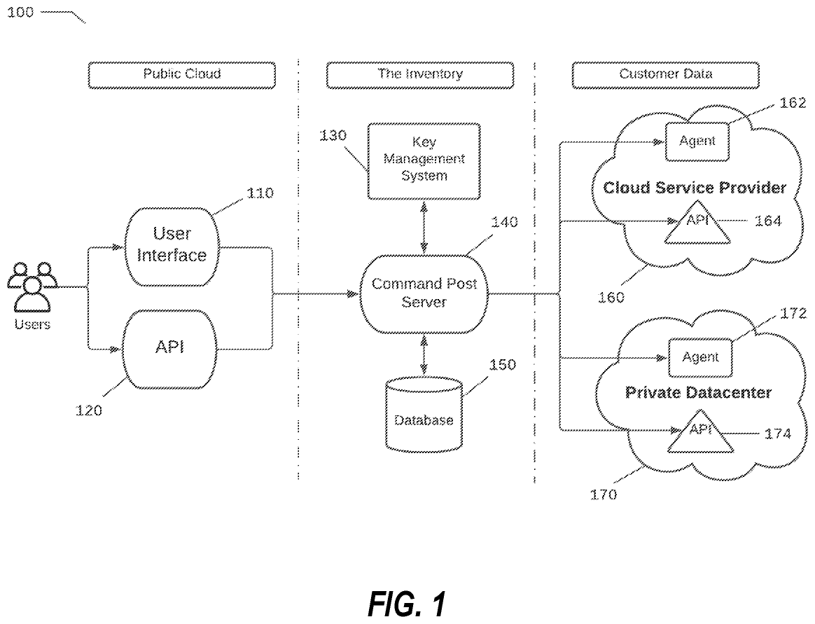

FIG. 1 is a block diagram conceptually illustrating inventory maintenance and access in accordance with an embodiment of the present disclosure. As noted above, the collection of cryptographic materials and information regarding the purpose of cryptographic materials within a target environment currently involves time-consuming and inherently error prone manual actions. Embodiments described herein seek to automate the process of creating/updating a cryptographic inventory (e.g., database 150) for one or more target environments, for example, including infrastructure and/or services within one or more cloud service providers (e.g., cloud service provider 160), within a private datacenter 170, and/or a colocation facility (not shown) utilized by a particular enterprise.

In one example, a server (e.g., server 140) external to the target environment may be used to collect existing cryptographic materials (e.g., keys, certificates, and the like) and information regarding assets (e.g., database services, storage services, and the like) that use these cryptographic materials that reside within the target environment. Copies of the collected cryptographic materials may be persisted within a key management system (KMS) 130 external to the target environment that may serve as a master copy, for example, for purposes of populating a KMS (270, 426) within the target environment or as a backup in case cryptographic material is lost, overwritten, or otherwise destroyed within the target environment. The master copy may also be used to reverse (unroll) an automated or manual cryptographic action (e.g., a key roll).

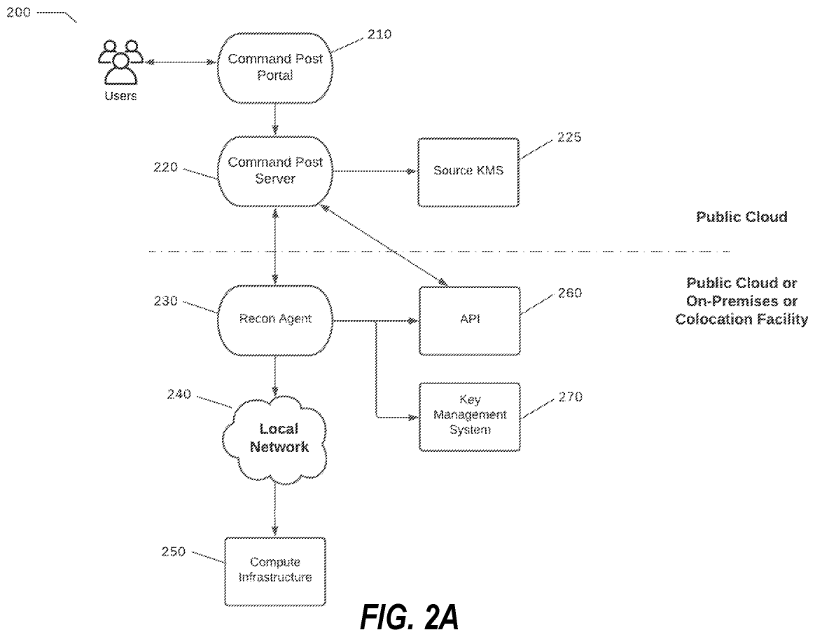

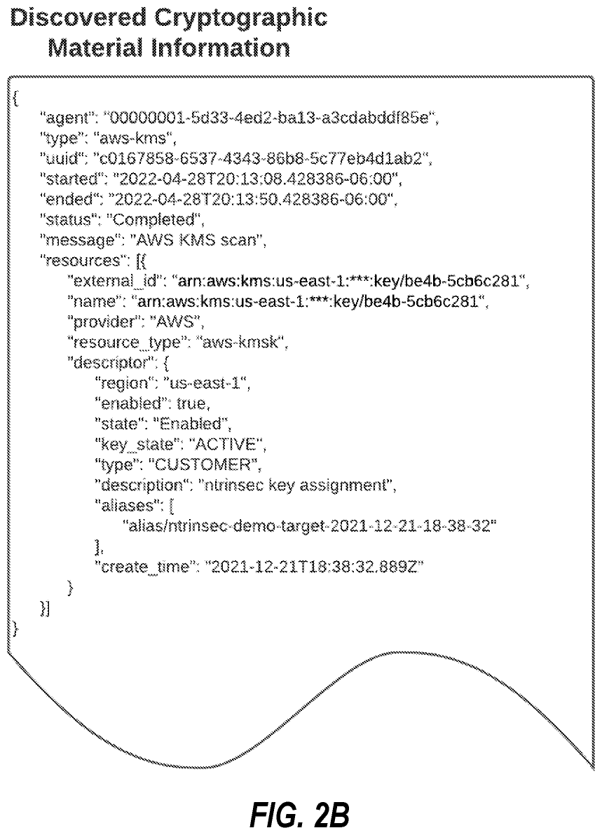

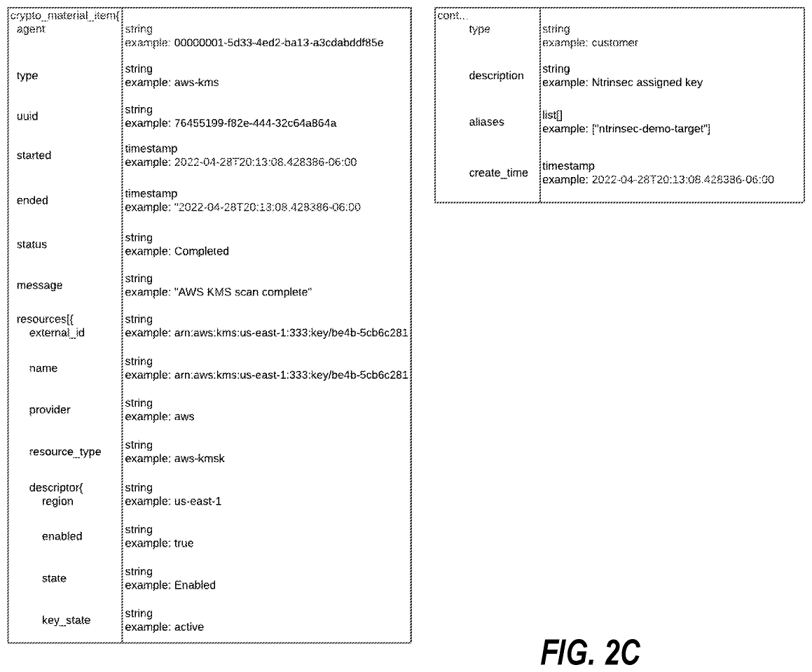

As described further below, the server 140 and/or an agent 162 or 172 deployed within the target environment may be used to facilitate collection of desired cryptographic inventory information. For example, using one or both of the server 140 and the agent (e.g., agent 162 or 172, as the case may be), a cryptographic management system (which may be provided to customers via a Software-as-a-Service (SaaS) delivery model as described below with reference to FIG. 2A), identifies usage purposes of discovered keys and/or the correlation between a service and its use of a key management service (KMS) or other encryption service using various approaches described below. While only one command post server 140 is shown, it is to be appreciated there may be one command post server 140 for each target environment.

In order to facilitate the use of manual and/or automated cryptographic actions (e.g., a key roll), for example, via a user interface 110 and/or an API 120, respectively, the collected information may be enriched to create a mapping between each particular asset and the cryptographic material the particular asset is using. Enrichment of the collected information may also include storing information regarding relationships between a given asset and other data correlated with the given asset (e.g., cryptographic material and its use, the number of connected assets to the given asset, the classification of the listener port in use by the given asset, cryptographic material in use by the assets that are connected to the given asset, etc.).

### Example Software-as-a-Service (SaaS) Delivery Model

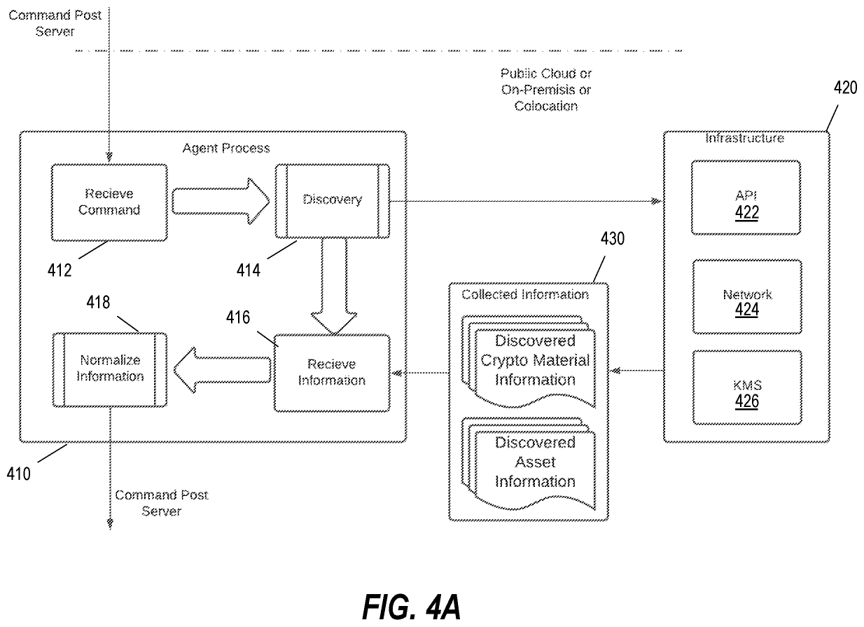

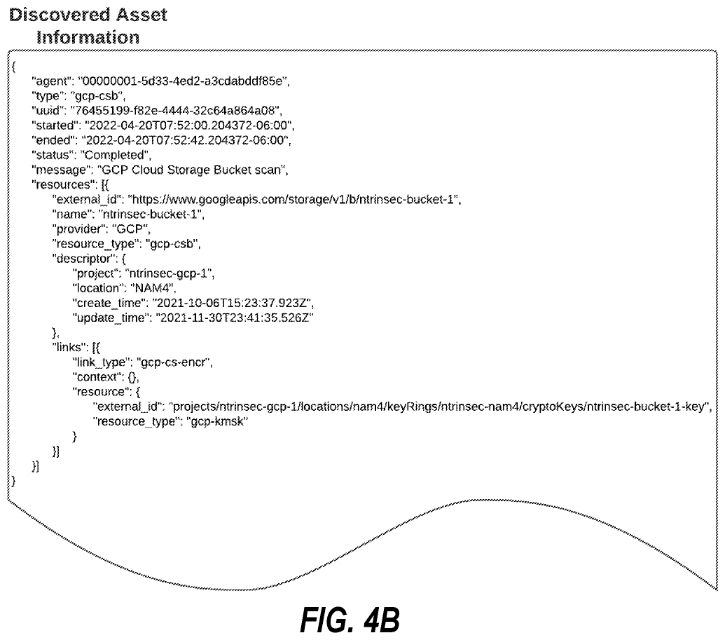

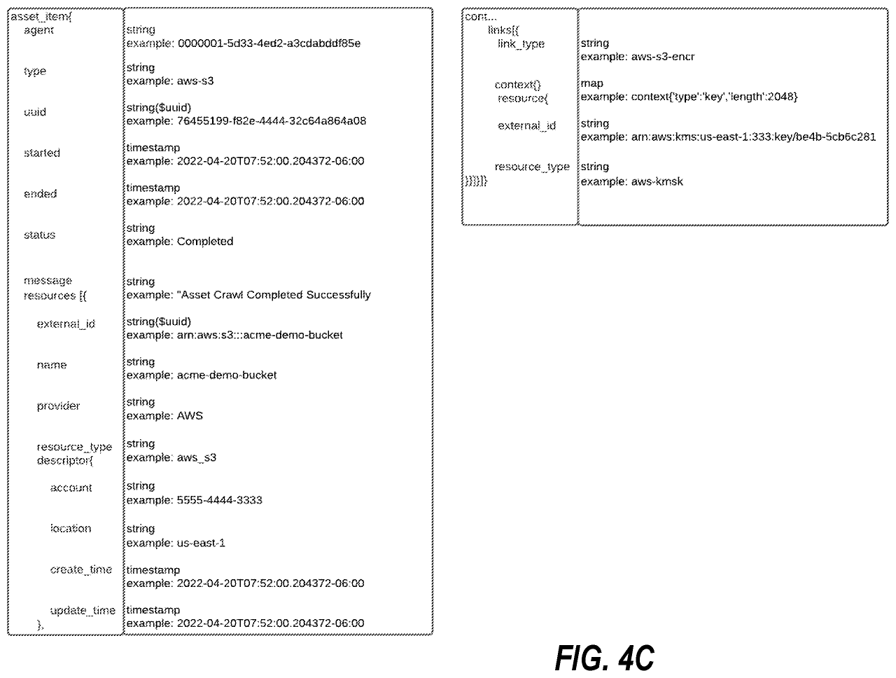

FIG. 2A is a block diagram illustrating a Software-as-a-Service (SaaS) delivery model 200 in accordance with an embodiment of the present disclosure. In the context of the present example, a SaaS platform including a portal (e.g., command post portal 210) a server (e.g., command post server 220) may be operable within a public cloud (e.g., Amazon Web Services (AWS), Google Cloud Platform (GCP), Microsoft Azure, or the like), and a source KMS 225, which may be analogous to KMS 130. In one embodiment, the SaaS platform facilitates automated discovery of information regarding existing cryptographic materials and information regarding assets residing within one or more target environments (e.g., a public, private, and/or hybrid cloud environment, a multi-cloud environment, an on-premises data center, a colocation facility, and/or a combination thereof) that use the cryptographic materials. Non-limiting examples of discovered cryptographic material and discovered asset information are illustrated by FIGS. 2B and 4B, respectively. Example data structures that may be populated for discovered cryptographic material and discovered assets within the target environment(s) are illustrated in FIGS. 2C and 4C, respectively.

A given target environment may represent an IT or service infrastructure utilized by an enterprise for its internal operations and/or may represent an IT or service infrastructure created by the enterprise for use by third parties. Regardless of the nature of the target environment, the SaaS platform may facilitate maintenance (e.g., creating and/or updating) of a cryptographic inventory for the target environment via the use of various external methods and/or internal methods to discover and collect existing cryptographic materials (e.g., keys, certificates, and the like) and information regarding assets that use these cryptographic materials that are associated with the target environment (e.g., reside within the target environment or are otherwise utilized by the target environment). Information may also be collected regarding assets capable of making use of cryptographic materials, but that are not currently using any of the discovered cryptographic material.

As described further below, the collected information may then be enriched to create a mapping (e.g., represented within or in the form of the cryptographic inventory) between each particular asset and the cryptographic material the particular asset is using, if any.

In one embodiment, customers or subscribers (e.g., users) of the SaaS platform may specify particular APIs to be used by a reconnaissance (recon) agent 230 and/or the server for collecting at least a subset of desired cryptographic inventory information. The APIs may include those exposed by one or more cloud service providers, those exposed by one or more internal services (e.g., a cluster management service or a container orchestration platform) of one or more cloud service providers, and/or those exposed by services deployed within an on-premise environment (e.g., a private datacenter). by The portal may also allow users to configure operations or functionality of the recon agent 230. For example, a user may specify the type or nature of services for which cryptographic material is to be identified. Users may also be provided with feedback (e.g., in the form of analytics, reports, and the like) regarding the results of the cryptographic inventory information collection process and/or analysis thereof.

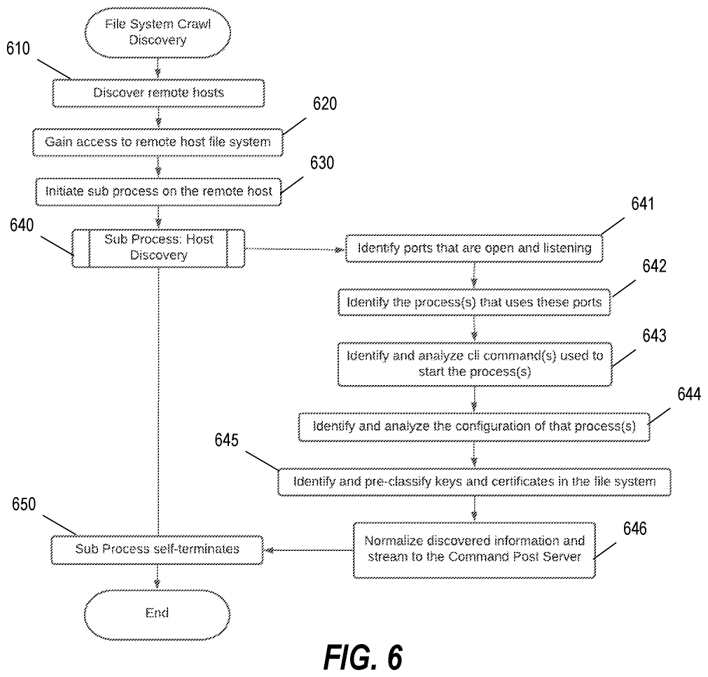

From outside of the target environment, the server may make use of external methods (e.g., making and analyzing requests to APIs (e.g., API 260), requests to a key management system/service (KMS) 270 or other encryption service and any other service which has been enabled to integrate or utilize encryption and/or the KMS 270). As described further below with reference to FIGS. 4A and 6, the recon agent 230 may make use of internal methods including crawling file system configurations for applications and/or services and querying database services. Alternatively or additionally, the recon agent 230 may make use of API 260 (e.g., a cloud API exposed by the cloud environment) and/or KMS 270 as part of its use of internal methods to collect desired cryptographic inventory information.

### Example Command Post Portal and Command Post Server

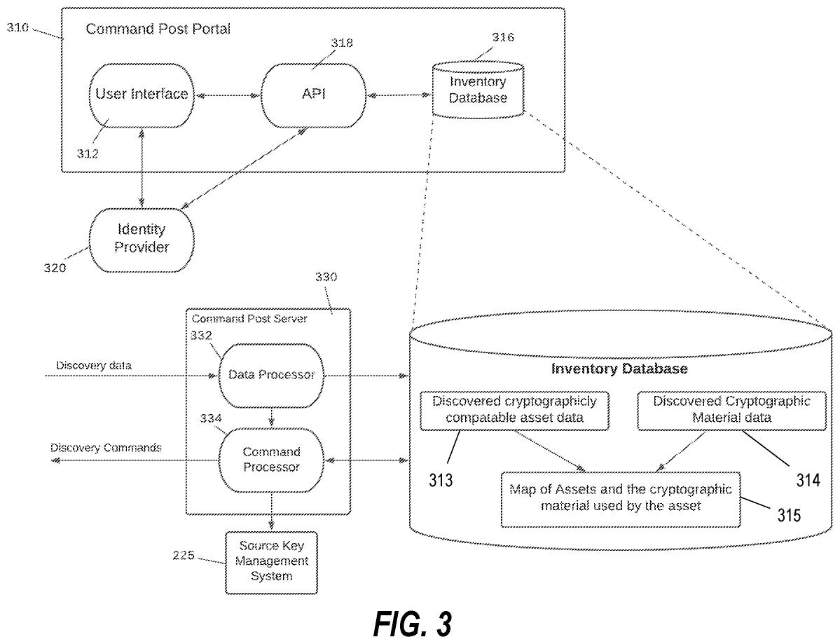

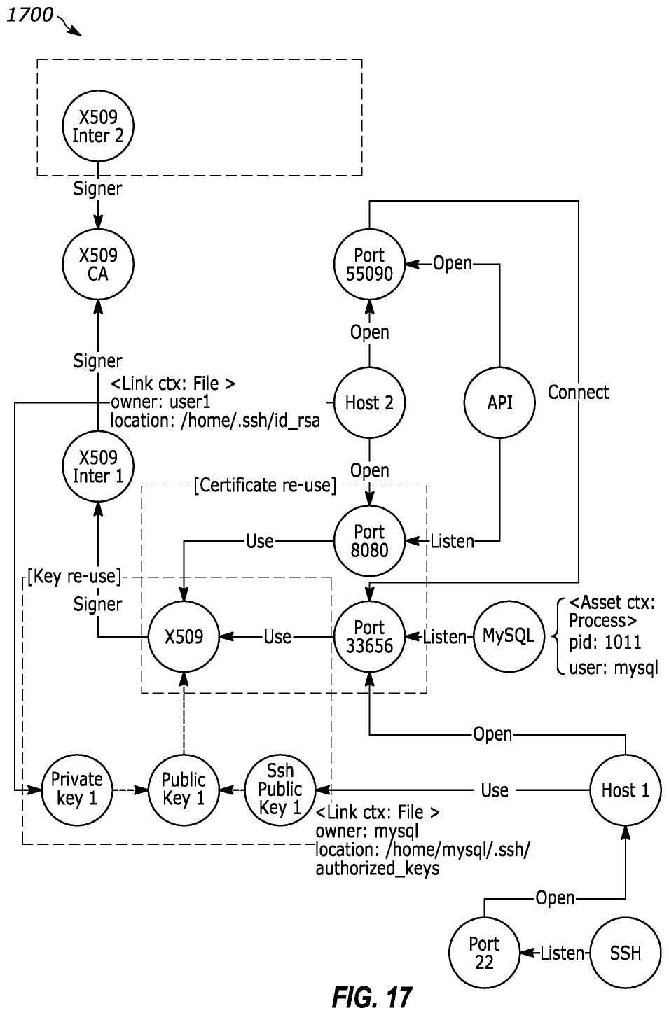

FIG. 3 is a block diagram illustrating a command post portal 310 and a command post server 330 in accordance with an embodiment of the present disclosure. Command post portal 310 may be analogous to command post portal 110 and command post server 330 may be analogous to command post server 140 or 220. In the context of the present example, the command post portal 310 includes a frontend in the form of a user interface 312 (which may be analogous to user interface 110), a backend in the form of an API 318 (which may be analogous to API 120), and a cryptographic inventory database (e.g., inventory database 316, which may be analogous to database 150). In one embodiment, the cryptographic inventory database may include all or some subset of the information shown in FIGS. 2C and 4C, for discovered cryptographic material 314 and discovered assets 313, respectively. API 318 may represent a representational state transfer (REST) API through which the command post portal 310 receives commands/requests/information from the user interface 312 and/or the command post server 330. According to one embodiment, the cryptographic inventory database may include or be represented in the form of a knowledge graph or semantic network, for example, as described below with reference to FIG. 17.

Access to the user interface 312 and use of the API 318 may be controlled by an identity provider 320, for example, that offers user authentication as a service. The user interface 312 may allow the user to, among other things, select or identify specific cloud services or applications (e.g., a container orchestration platform (e.g., Kubernetes), a container runtime (e.g., Docker), an object storage service, such as AWS S3, a managed relational database service (RDS), such as AWS RDS, a database management system, such as MySQL, and the like) as targets from which cryptographic inventory information is to be collected. For example, cryptographic material that is used by an asset (e.g., network ports that use x509 for TLS, data at rest encryption, etc.), can receive ad-hoc discovery commands to be executed at an arbitrary point in time. Additionally, in one embodiment, due to the source-agnostic nature of cryptographic inventory information, a user may select assets that reside within more than one public cloud service provider (multi-cloud) environment or an on-premise environment that can reside in the same or different data centers. A user may select assets that reside in an on-premise (private cloud) environment and configure, for example, a file system crawl type discovery be performed for the common network endpoint devices residing in such environments. Another example of user interface actions includes customizable security policies, or configuration of best practice standards, or both for identifying, monitoring, and triggering security events to correlate with. For example, a user may choose to identify cryptographic material as expired using a custom time parameter. These parameters may be utilized by various analysis functions described herein.

In this example, the command post server 330 interfaces with and KMS 225 and includes a data processor 332 and a command processor server 334. The data processor 332 may receive information regarding discovered cryptographic material and/or discovered assets and update the inventory database 316 based thereon. The command processor 334 may cause various discovery commands to be performed. Depending upon the particular implementation, the command processor 334 may execute discovery commands directly or indirectly through use of an agent (e.g., recon agent 230) deployed within the target environment.

### Example Recon Agent

FIG. 4A is a block diagram illustrating example agent interactions with infrastructure 420 of a target environment to discover cryptographic material and associated assets within the target environment in accordance with an embodiment of the present disclosure. Depending upon the particular implementation, the agent may discover assets within the target environment that are capable of using encryption, but may not be configured to do so at the time of discovery. In one embodiment, a suggestion may be proved to the end user, for example, via user interface 110 or 312 that encryption should be applied and/or used for such assets.

In the context of the present example, a recon agent (e.g., recon agent 230) has been deployed within the target environment and awaits receipt of commands from a command post server (e.g., command post server 220 or 330).

Depending upon the particular implementation, the recon agent may be the mechanism through which various forms of internal or external discovery (e.g., host discovery, database discovery, identification of stale systems, identification of orphaned systems, etc.) may be initiated and/or other actions (e.g., key roll, cryptographic material exchange, etc.) may be initiated. For example, the recon agent may be responsible for receiving commands from the command post server, causing a host discovery process 414 to be performed, receive information 416 returned (e.g., collected information 430) as a result performance of the host discovery process 414, normalizing the information 418, and returning the normalized information to the command post server. For example, responsive to receipt of commands 412, the recon agent may prioritize and execute the commands. In one embodiment, when the received discovery command calls for use of API 422 to discover the desired cryptographic inventory information, the recon agent may interact with API 422 and based on cryptographic material identified by such interactions may retrieve cryptographic material from KMS 426 (which may be analogous to KMS 270). In one embodiment, when the discovery command calls for file system crawling, the recon agent may perform a file system crawl discovery process as described further below with reference to FIG. 6 The file system crawling process represents a non-limiting example of an internal method that may be used to collect desired cryptographic inventory information. Responsive to receiving information of interest from the infrastructure 420 or from the file system crawling process that is to be included within the cryptographic inventory (e.g., collected information 430), the recon agent may normalize the information 418, for example, by organizing the information in a manner that makes it easier for consumption by the command post server and provide the information to the command post server.

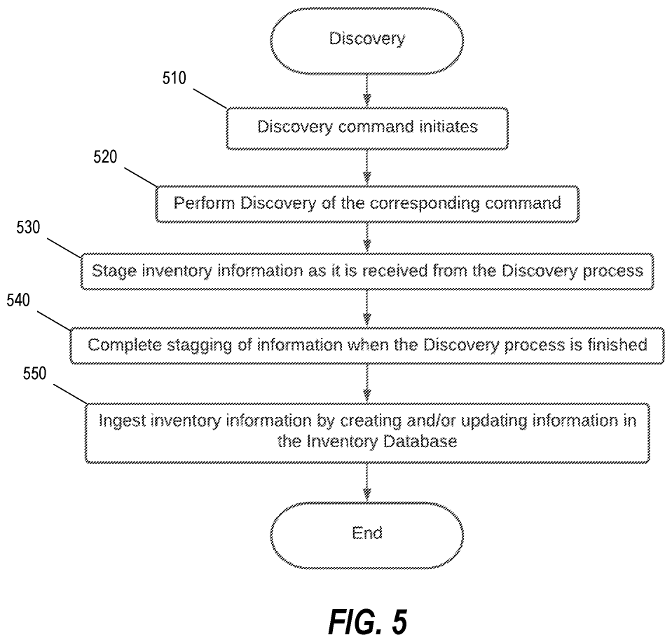

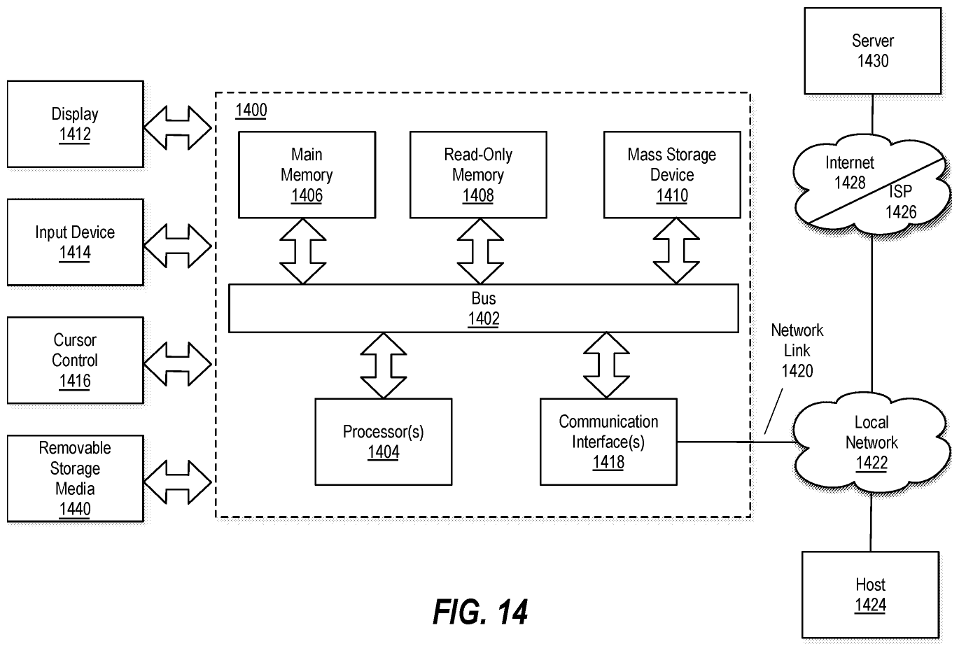

Various functional units described herein (e.g., the recon agent, the command post portal, and the command post server) and the processing described below with reference to the flow diagrams of FIGS. 5-13 may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, the processing may be performed by one or more virtual or physical computer systems of various forms, such as the computer system described with reference to FIG. 14 below.

### Example Representation of Cryptographic Inventory Database

FIG. 17 is a knowledge graph diagram 1700 illustrating the use of data from a cryptographic inventory database to determine security risks and/or to facilitate automated mitigation of security risks in accordance with an embodiment of the present disclosure. The cryptographic inventory database (which may be analogous to database 150 or inventory database 316) may include or be represented in the form of a cryptographic knowledge graph. A knowledge graph, also known as a semantic network, represents a network of real-world entities (e.g., objects, events, situations, and/or concepts) and illustrates the relationship between them. This information may be stored in a graph database and visualized as a graph structure, prompting the term knowledge “graph”. A knowledge graph is made up of three main components: nodes, edges, and labels. In one embodiment, the nodes of the knowledge graph may represent discovered resources (e.g., assets and cryptographic material) and the edges connecting a given pair of nodes may represent the various discovered, correlated, and/or derived relations. Each node and/or edge may have additional associated context represented as a set of key-value attributes. For each type of asset or cryptographic material and/or relation between those there is a well-defined set of key-value attributes. A well-defined set of labels for each type of edge may be used to identify a particular relation. For example, “ssh key” may be a label for a private or public key used to establish a secure shell protocol (SSH) connection.

While in the context of the present example, a cryptographic inventory database may include or be represented in the form of a knowledge graph or a semantic network, it is to be appreciated in some examples the cryptographic inventory database may be represented in the form of a relational database.

### Example Discovery Process

FIG. 5 is a flow diagram illustrating a set of operations for performing a process to discover a cryptographic inventory associated with a target environment in accordance with an embodiment of the present disclosure. The discovery process described with reference to FIG. 5 may be performed by a recon agent (e.g., recon agent 230) responsive to receipt of discovery command from a command post server (e.g., command post server 140 or 220).

At block 510, the discovery command initiates. In one embodiment, the discovery command may specify a specific cloud service for which the recon agent is to collect the cryptographic inventory. Alternatively or additionally, the discovery command may provide a set of instructions (e.g., a pre-configured playbook defined for a particular cloud service) for collecting the cryptographic inventory information.

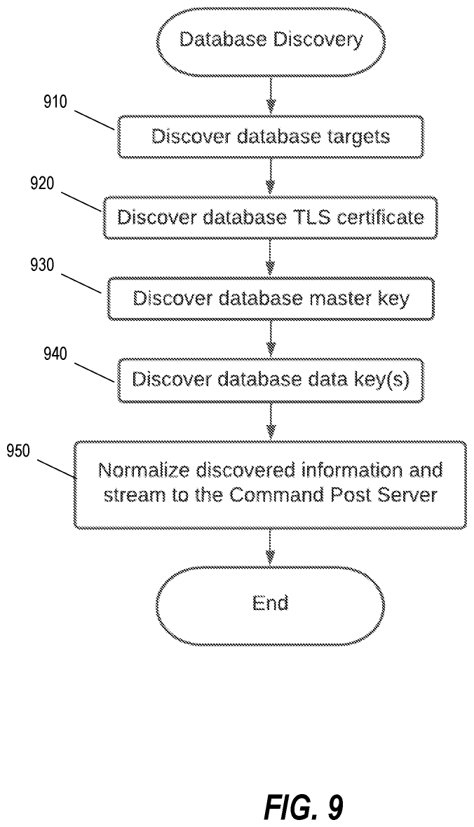

At block 520, the recon agent or server process performs discovery of the corresponding command, for example, instructions to discover the cryptographic inventory information are executed. The instructions may cause the recon agent or any other corresponding process to interact with one or more APIs exposed by a cloud service provider (e.g., API 164 of cloud service provider 160) or may cause the recon agent to perform a file system crawl discovery process as described further below with reference to FIG. 6. In the case of the former, the recon agent may execute instructions, for example, provided in the form of a set of instructions as part of the discovery command. Using AWS S3 as a non-limiting example of a service that might be provided by a cloud service provider, the instructions may include directives to (i) interrogate an S3 API (which may represent a non-limiting example of API 164, 260, and 322), (ii) list buckets, (iii) request information regarding each bucket to obtain assigned keys (e.g., identified by their respective key identifiers (IDs), which may be used to locate them within a KMS, such as KMS 270) (iv) list objects within each bucket, and (v) determine on an object-by-object basis what the encryption is, if any. Another example, a network-based discovery may identify a network endpoint listener on port 3306 and the discovery process further identifies the MySQL protocol is accepted by the port listener. This discovery example results show a certificate trust chain and through data enrichment and analysis functions determine the source certificates are managed within a KMS. These example results could generate additional discovery processes without human interaction. One such additional discovery process may be a file system crawl of the identified network endpoint automatically identified as a target for discovery. Additionally, the MySQL discovery process may be initiated in an automated process without human interaction, for example, as described further below with reference to FIG. 9.

At block 530, inventory information is staged as it is received from the discovery process. Assuming cryptographic inventory information has been discovered, the collected information (e.g., collected information 430) is received by the recon agent and may be normalized to facilitate consumption by the command post server.

At block 550, the recon agent facilitates the creation of a mapping between the asset at issue within the target environment and the cryptographic material used by the asset by returning the collected information (e.g., information regarding one or more keys and/or certificates and information regarding the asset) to the command post server, which receives the data and creates/updates the cryptographic inventory. In some situations, the asset at issue may be operable to use cryptographic material but may not currently be configured to make use of cryptographic material. For example, a cryptographic key may not have been assigned for use by the asset at issue. This may be flagged in the cryptographic inventory, for example, in a database (e.g., database 150 or 316) as an action item for review.

### Example File System Crawling

FIG. 6 is a flow diagram illustrating a set of operations for performing a file system crawling process in accordance with an embodiment of the present disclosure. The process described with reference to FIG. 6 may be performed by a recon agent (e.g., recon agent 230, agent 162 or 172, or agent 410)

At block 610, remote hosts may be discovered. For example, the recon agent may use the Address Resolution Protocol (ARP) scan tool to or an IP ping tool to obtain information regarding all active IPv4 devices on a particular subnet.

At block 620, the recon agent may connect to a particular host of the discovered remote hosts. For example, the recon agent may use the secure shell protocol (SSH) or WinRM to access the particular host.

At block 630, the recon agent may initiate a sub-process on the particular host to cause the sub-process to perform a host discovery process on the particular host (block 640).

In the context of the present example, blocks 641-646 represent various actions that may be performed by the sub-process during the host discovery process (which may also be referred to herein as a file system crawling process).

At block 641, the sub-process may identify ports that are open and listening. In one embodiment, for each of the identified ports, the sub-process may then perform blocks 642-646.

At block 642, the sub-process may find one or more processes that are using the port at issue.

At block 643, the sub-process may find the command that started the one or more processes.

At block 644, the sub-process may find the configuration of the command and the one or more processes.

At block 645, based on the configuration found in block 644, the sub-process may discover keys and certificates in the file system.

At block 646, the sub-process normalizes the discovered information and sends the collected information to the recon agent, for example, to be streamed to the command post server.

At block 650, the sub-process may self-terminate.

While for sake of brevity, in the context of the above example, the agent is described as connecting to and initiating a sub-process on one remote host to discover cryptographic material in the file system, it is to be appreciated this file system crawling process may be performed on each remote host discovered in block 610. It is also to be appreciated that an agentless discovery approach may be employed. For example, the command post server may make use of various controls and services offered by a particular CSP. Using these controls and services it is possible to gain access to the file system of a particular remote host and subsequently initiate the full file system crawl discovery process. Alternatively, the sub-process may be selectively performed on a permissible set (e.g., by a specified IP address range, by a specified list of host names, or the like) of discovered hosts configured, for example, via a user interface (e.g., user interface 110 or 312). As yet another alternative, the sub-process may be selectively performed on a set of discovered hosts by first determining a likelihood of a given host having desired cryptographic inventory information.

### Example Agent Deployment

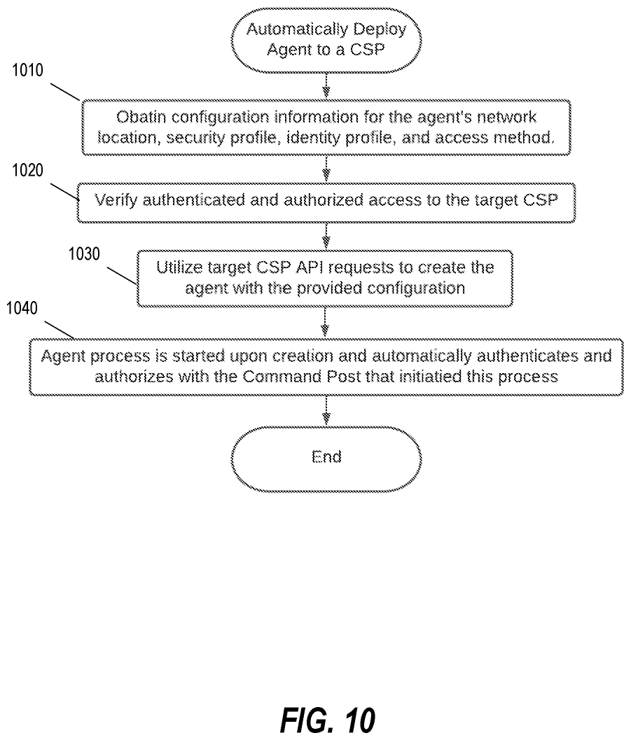

FIG. 10 is a flow diagram illustrating a set of operations for deploying an agent within a target environment in accordance with an embodiment of the present disclosure. The process described with reference to FIG. 10 may be performed by a command post server (e.g., command post server 140 or 220).

At block 1010, the configuration for the agent (e.g., agent 162 or recon agent 230) is obtained, including, for example, the agent's IP address, security profile, and identity profile.

At block 1020, authenticated and authorized access to the target cloud service provider (CSP), e.g., cloud service provider 160, is verified.

At block 1030, the agent is created in the public cloud. For example, the command post server may create the agent with the provided configuration within the public cloud by making use of an API (e.g., API 164) exposed by the public cloud.

At block 1040, the agent process is started and automatically authenticates and authorizes with the command post that initiated the process. At this point, the agent is ready to receive commands from the command post server.

While in the context of the present example, the agent is described as being deployed within a single target environment comprising a public cloud, it is to be appreciated such an agent may be deployed within multiple target environments, for example, including a private datacenter (e.g., private datacenter 170), a colocation facility, and/or one or more public clouds.

### Example Database Discovery

FIG. 9 is a flow diagram illustrating a set of operations for performing database discovery in accordance with an embodiment of the present disclosure.

At block 910, a classified listener port may be discovered that uses a database protocol (e.g., MySQL, PostgreSQL, MSSQL, Cassandra, etc.).

At block 920, the listener port may be interrogated from one or more sources, a remote host or file system crawl where a cryptographic certificate is identified as in use by the database for encrypting TLS connections.

At block 930, the database configuration is interrogated to discover if a master encryption key is used (e.g., Master Table Encryption).

At block 940, the database configuration is interrogated to discover if a data encryption key is used (e.g., Transparent Data Encryption).

At block 950, the discovered information is normalized and sent to the command post server for data ingestion.

### High-Level Security Risk Mitigation Approach

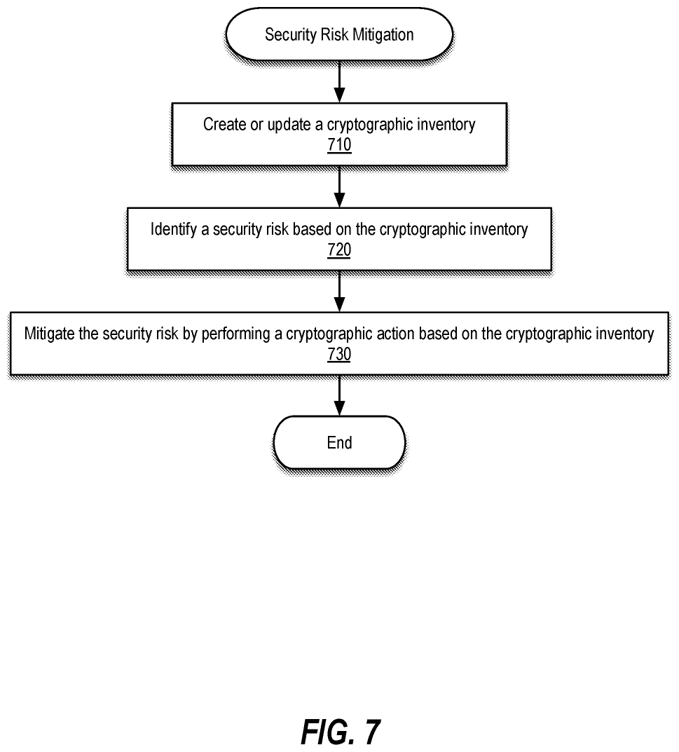

FIG. 7 is a flow diagram illustrating a set of operations for mitigation of a security risk in accordance with an embodiment of the present disclosure. The process described with reference to FIG. 7 may involve various forms of internal or external discovery performed or coordinated by a server (e.g., command post server 220 or 330), for example, associated with a cryptographic management system delivered in accordance with a SaaS-based delivery model and/or a recon agent (e.g., recon agent 230, agent 162 or 172, or agent 410) deployed by the server.

At block 710, a cryptographic inventory (e.g., database 150 or inventory database 316) is created or updated. According to one embodiment, cryptographic resources (e.g., assets and respective cryptographic material used by the assets) within one or more target environments may be discovered, for example, via one or more of (i) file system discovery, including crawling file systems mounted on operating system hosts of a first target environment (e.g., a private datacenter) and (ii) API discovery, including interrogating an API exposed by a service provided by a cloud service provider representing a second target environment (e.g., a public cloud).

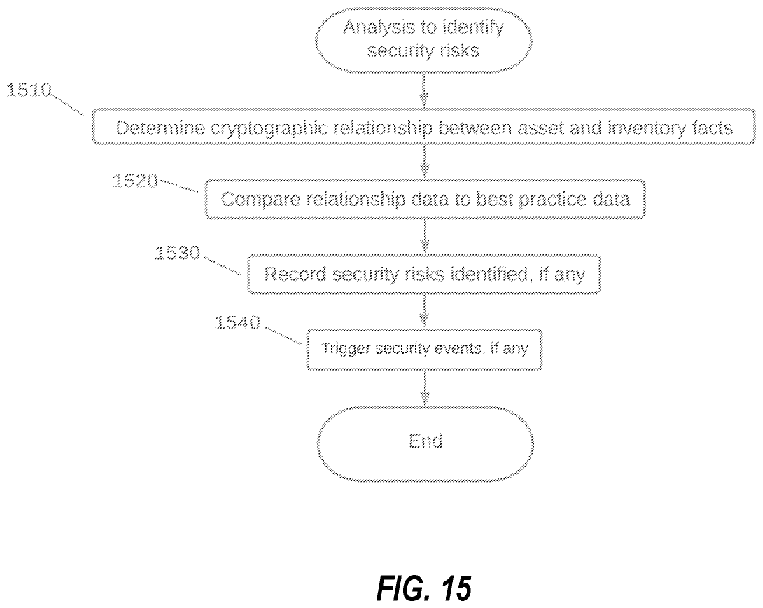

At block 720, a security risk is identified based on the cryptographic inventory. For example, the cryptographic inventory may be analyzed to determine relationships among the cryptographic resources and/or inventory facts. A non-limiting example of analysis to identify security risks is described further below with reference to FIG. 15.

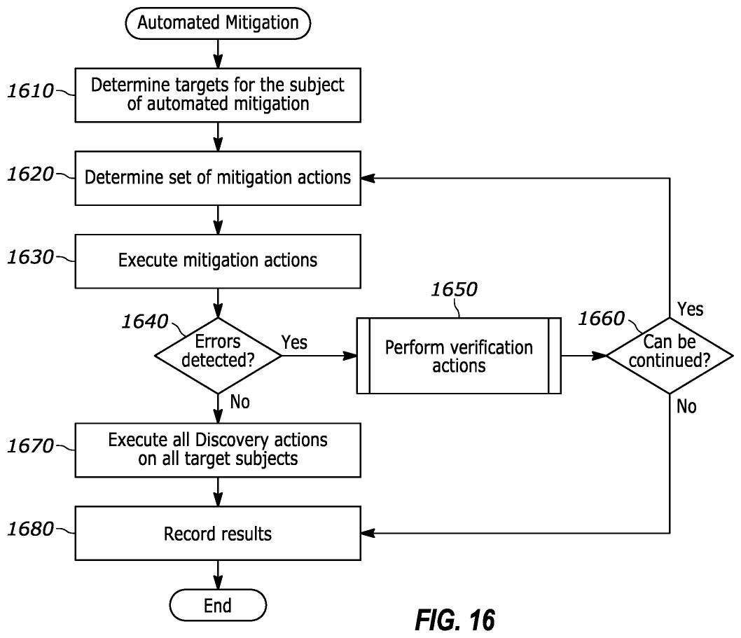

At block 730, the security risk is mitigated by performing a cryptographic action based on the cryptographic inventory. According to one embodiment, a user of the cryptographic management system may be notified of the security risk and prompted. In some examples, human involvement may be minimized by allowing the user to set mitigation preferences (e.g., automatic or manual) for various types of security risks. In this manner, some forms of mitigation (e.g., in the form of one or more cryptographic actions) may be performed automatically responsive to identification of a security risk while other forms of mitigation may be performed after receiving explicit approval (e.g., via UI 110). A non-limiting example of automated mitigation is described below with reference to FIG. 16.

### Example of Creating/Updating a Cryptographic Inventory

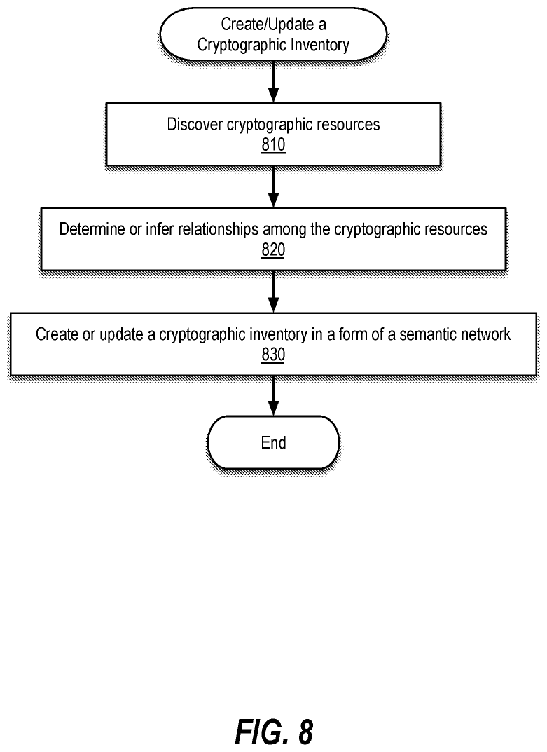

FIG. 8 is a flow diagram illustrating a set of operations for creating/updating a cryptographic inventory in accordance with an embodiment of the present disclosure. The process described with reference to FIG. 8 may involve various forms of internal or external discovery performed or coordinated by a server (e.g., command post server 220 or 330), for example, associated with a cryptographic management system delivered in accordance with a SaaS-based delivery model and/or a recon agent (e.g., recon agent 230, agent 162 or 172, or agent 410) deployed by the server.

At block 810, cryptographic resources (e.g., assets and respective cryptographic material used by the assets) are discovered. In one embodiment, the discovery may be configured to be performed for one or more target environments, for example, utilized by an enterprise. As described above with reference to FIG. 7, the cryptographic resources may be discovered, for example, via one or more of (i) file system discovery, including crawling file systems mounted on operating system hosts of a first target environment (e.g., a private datacenter) and (ii) API discovery, including interrogating an API exposed by a service provided by a cloud service provider representing a second target environment (e.g., a public cloud).

At block 820, relationships among the cryptographic resources may be determined or inferred. The relationships may be determined based at least in part on the cryptographic inventory created/updated in block 810. There are a number of ways such relationships may be determined or inferred. According to one embodiment, deep packet inspection (DPI) may be employed to gain information regarding applications or services being utilized by various hosts or assets within a target environment and/or to ascertain which assets may be in communication with other assets. For example, an agent (e.g., recon agent 230, agent 162 or 172, or agent 410) may examine the content of data packets observed within a given network within which it is deployed. Another non-limiting example of how relationships may be determined includes correlation between a service and its use of a KSM or other encryption service. Additionally, inventory information discovered from one or more public cloud environments may be correlated with inventory information discovered from an on-premise environment.

At block 830, the cryptographic inventory is created or updated as appropriate, for example, in the form of a knowledge graph or a semantic network. A non-limiting example of how such a semantic network may be utilized in connection with determining the existence of security risks and facilitating the automated or manual mitigation of security risks is described with reference to FIG. 17. In one embodiment, the automated discovery of cryptographic resources and relationships among them significantly reduces or eliminates the existence of shadow inventory (e.g., representing those cryptographic resources of a target environment that are not identified by or otherwise overlooked by manual approaches that attempt to document cryptographic resources). As a result of the increased accuracy of the cryptographic inventory created by the automated cryptographic resource discovery approaches described herein and in view of the enriched data contained therein, sufficient confidence may be instilled in users to trust allowing the cryptographic management system to perform automated cryptographic actions, which, in one embodiment, are facilitated by representing the cryptographic inventory in the form of a knowledge graph or a semantic network. As will be appreciated by those skilled in the art, automated key rotation may be performed with accuracy and within timeframes incapable of being matched by traditional manual use of the patchwork of tools currently available for gathering information regarding cryptographic resources. In one embodiment, automated key rotation may be performed at a high cadence (e.g., 1 hour or less, 20 minutes or less, or in a matter of seconds, depending on the number of cryptographic resources at issue) for a given organization (e.g., comprising or making use of one or more target environments), thereby facilitating reduction of the cryptoperiod to a point at which it is infeasible for the encryption to be broken via known security exploits. That is, the cryptoperiod can be reduced to a period of time that is shorter than that which is required to compromise a key, for example, via a side-channel attack.

### Example Use of Cryptographic Inventory to Identify a Security Risk

FIG. 15 is a flow diagram illustrating operations for identifying security risks in accordance with an embodiment of the present disclosure. The process described with reference to FIG. 15 may be performed or coordinated by a server (e.g., command post server 220 or 330), for example, associated with a cryptographic management system delivered in accordance with a SaaS-based delivery model. According to one embodiment, a series of steps are performed to analyze cryptographic inventory information. Collectively these steps seek to gather sufficient intelligence (e.g., provide information to facilitate identification of security risks in inter-system communication, computer programs, identity management systems, and the like. These analysis steps may identify security risks including, but not limited to, key reuse, cryptographic material expiration, cryptographic erase, potential cryptographic erase, malformed KMS or HSM key, key compromise, stale systems, IOA, and the like. An identified risk may automatically trigger a new series of actions such as additional discoveries, analysis, or mitigation actions, or a combination of each. Alternatively, responsive to identification of one or more security risks (e.g., lack of compliance with best practice data), security recommendations may be provided to a user of the cryptographic management system (e.g., via UI 110) to give the user an opportunity to review and consider the security recommendations before launching an automated process to implement a given security recommendation.

At block 1510, analysis of cryptographic inventory information, in particular the recorded state of relationships between a target asset and other data correlated with this asset (e.g., cryptographic material and its use, the number of connected assets to this asset, the classification of the listener port in use by the asset, cryptographic material in use by the assets that are connected to this asset, etc.) along with the asset(s) are compared (e.g., at block 1520) with appropriate parameters, for example, provided by best practice data, which may be defined by common standards (e.g., MST Special Publication 800 series or Federal Information Processing Standards (EPS)), and/or any superseding custom parameters provided by user input.

At block 1530, results of this analysis are recorded in a particular table in the cryptographic in database.

At block 1540, any identified violation within this analysis may automatically trigger mitigation actions. Various example mitigations actions are described herein. For example, the system may identify a security risk called “key reuse”, when copies of the same cryptographic material are used or can potentially be used by at least two (2) separate instances of asset types, additionally, when more than one asset within a type category which is designated as sensitive data or applications, are using copies of the same cryptographic material. Another example, may result from parameters configured by user input, supersede default standards, of which are used for analysis as a conditional to identify security risks, which may be updated when the applicable common standards are updated.

In one embodiment, analysis of cryptographic inventory facts or a combination of facts may be used to identify the length of time cryptographic material should be active (i.e., cryptoperiod) correlated with usage category types. The cryptoperiod threshold may be set by default with best practice standards, for example, as set forth in standards (e.g., the NIST 800 series special publications or TIPS. Cryptographic material analysis results indicative of a violation of the cryptoperiod threshold may be identified as a security risk that may be referred to as “cryptographic material expiration.”

In the process of analysis steps of cryptographic inventory facts or the combination of facts, it can be determined that such cryptographic objects or assets configured to use cryptographic material, have cryptographic material that no longer exists or has been observed to have been destroyed. Such facts and circumstances represent a security risk that may be referred to as “cryptographic erase.” Through the observance of these facts over time, it may be determined that cryptographic material is predicted to be destroyed at a specific future date and identifies a possible security risk that may be referred to as “potential cryptographic erase.”

The provisioning and changing of cryptographic material within a managed system such as, but not limited, a Key Management System or Service or a Hardware Security Module can render such cryptographic material unusable. Such facts and circumstances may be indicative of this cryptographic material representing a security risk that may be referred to as “malformed KMS or HSM key.”

Users of the system or the system itself may observe suspicious activity (e.g., an IOA) that involves assets and associated cryptographic material. When such suspicious activity represent a high probability of a key having been disclosed to an unauthorized person or an unauthorized person otherwise having access to it, such circumstances may be indicative of a security risk referred to as a “key compromise.” In response to observing such suspicious activity the user or the system, as the case may be, can take action, for example, by identifying cryptographic material or a group of materials as (potentially) being compromised.

Cryptographic material may be discovered outside of a designated management system, application, or service, that is identified in the cryptographic inventory as an asset. A user may specify the appropriate asset for managing cryptographic material that may comprise of a boundary set by a particular geographic region or it can be assumed by this solution as the first discovery of an asset classified as a cryptographic management system. Cryptographic material discovered outside of this designated asset may be identified as a security risk referred to as “orphan cryptographic material.”

In another example, analysis of inventory facts or a combination of facts over time may be used to develop a usage model for modalities of cryptographic function(s) with user and machine identities being identified in at least one way as the requestor pattern and the response from the requested system identified in at least one way as the response pattern. Analysis of these patterns may allow the system to identify a baseline set of patterns where anomalous behavior detection is synchronized across multiple data points. Detecting patterns in usage dropping below default thresholds (e.g., which may be changed by users selecting to change configuration settings through the user interface or API), a system may be identified with a security risk referred to as a “stale system.”

As such, using analysis of these facts over time may identify baselines in usage patterns where relative longevity of communication patterns are used to identify longer periods of idle or zero communication between at least two (2) assets. New communication patterns or resurgence of old ones may be analyzed for consistency using a conditional rule base. Analysis results may identify anomalous behavior patterns that may be identified as a security risk referred to as an “indicator of attack” or IOA.

### Example Automated Mitigation

FIG. 16 is a flow diagram illustrating operations for automating mitigation actions to resolve security risks while minimizing human interaction in accordance with an embodiment of the present disclosure. Various actions may be required for mitigating each particular security risk. As these actions are executed and result in either a success or a failure, new actions may be required. Some of the actions may be known prior to their execution and some may not be known until an action execution is complete and the result is known. Therefore, according to one embodiment, a rule base may be used to dynamically organize sequences of actions into a set of actions. Each set of actions contains one or more actions that can be chosen by the automation of the rule base to be used for mitigating a specific security risk.

At block 1610, the first step identifies the target(s) for the given mitigation subject(s) for change based on a security event and the cryptographic inventory facts related to this target(s).

At block 1620, each set of mitigation actions are preconfigured to support particular asset types and particular assets, as designated in a particular table in the cryptographic inventory database. The set of mitigation actions used for this mitigation may be built by a rule base based on mitigation actions and assets described above by using target(s) and related cryptographic inventory facts as input parameters. The output may be a particular set of required mitigation actions.

At block 1630, the set of mitigation actions are executed.

At decision block 1640, when errors are the result of mitigation actions being executed the processing branches to block 1650, otherwise the processing continues to block 1670.

At block 1650, verify state of all subject(s) and related cryptographic inventory facts in order to provide enough data for a rules-based engine in block 1660, to make a decision if the original mitigation should be stopped due to an error or it can be continued (e.g., block 1660), and that may trigger execution of respective discovery processes. The result of these actions can be a successful discovery or they can determine changes are necessary and, if possible, execute the changes automatically.

At decision block 1660, the results of block 1650 are processed by a rules engine to determine if the original mitigation should be stopped due to an error or if it can be continued. If the original mitigation sequence cannot be continued then processing branches to block 1680, otherwise processing returns to block 1620.

at block 1670, Output from the rules engine may include respective post actions for all subject(s) and related cryptographic inventory facts, and any new assets or cryptographic material created by this process (e.g., discovery, analysis, etc.). These actions are executed to keep cryptographic inventory up to date in a consistent state.

At block 1680, Results from each executed action is recorded in a particular table in the cryptographic inventory database being incorporated into the knowledge graph.

### Example Key Roll

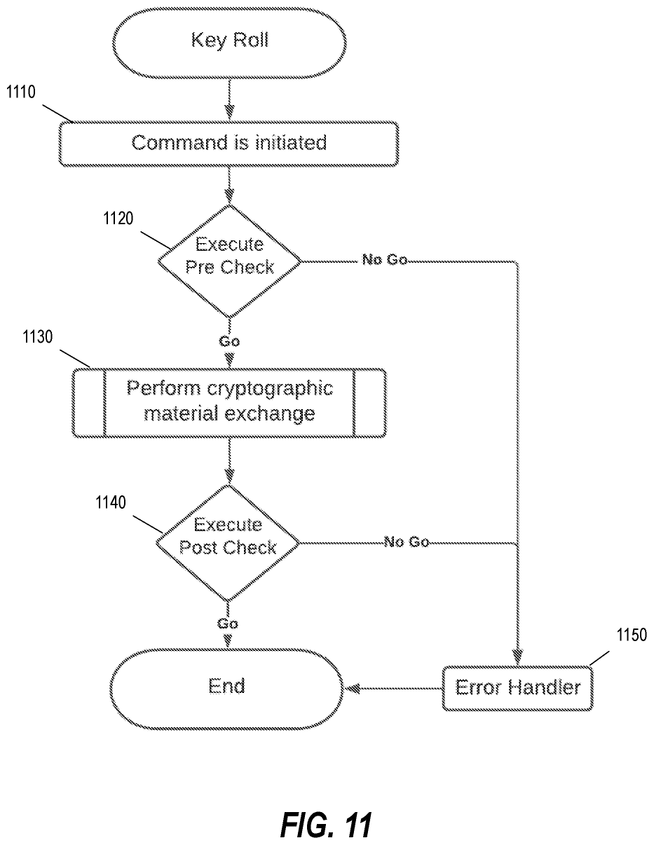

FIG. 11 is a flow diagram illustrating a set of operations for performing a key roll in accordance with an embodiment of the present disclosure. The process described with reference to FIG. 11 may be performed or coordinated by a server (e.g., command post server 220 or 330), for example, associated with a cryptographic management system delivered in accordance with a SaaS-based delivery model.

At block 1110, the command to perform the key roll is initiated. The key roll may be manually initiated by a user via a user interface (e.g., user interface 110 or 312) or programmatically via an API (e.g., API 120 or 318).

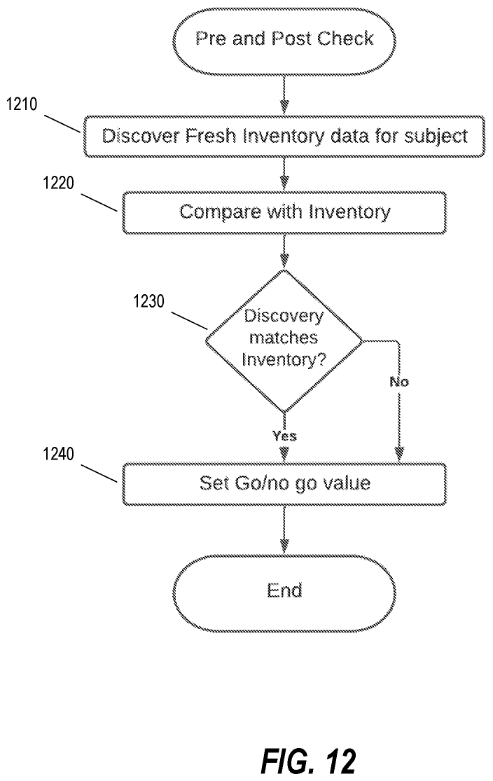

At decision block 1120, a pre-check may be performed to make a go-no-go determination. When the pre-check indicates the performance of the key roll is a go, processing continues with block 1130; otherwise, when the pre-check indicates the performance of the key roll is a no go, processing branches to block 1150. An example of pre-check and/or post-check processing is illustrated by FIG. 12.

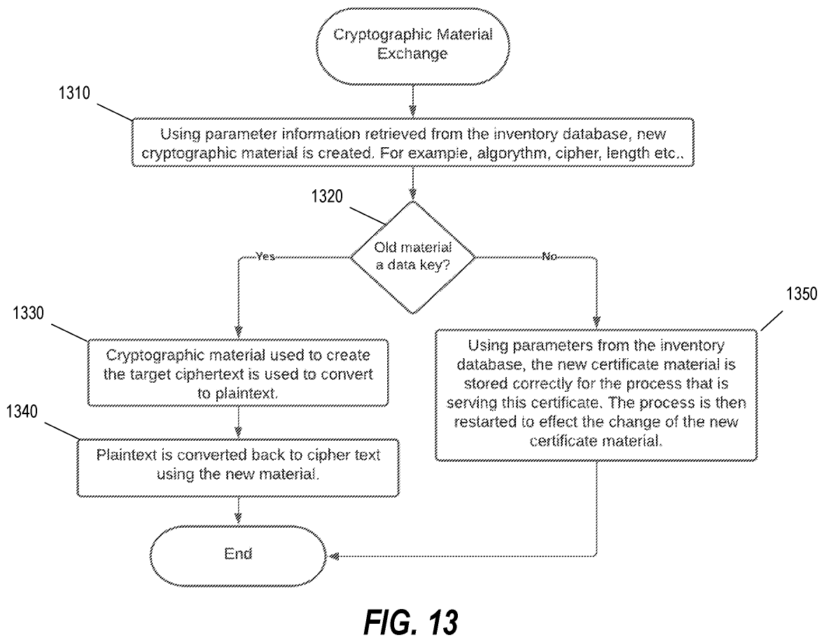

At block 1130, a cryptographic material exchange process is performed. For example, the cryptographic material exchange process illustrated by FIG. 13 may be performed to replace existing cryptographic material with newly created cryptographic material.

At decision block 1140, a post-check may be performed to make a go-no-go determination. When the post-check indicates the key roll was successful, processing is complete; otherwise, processing continues with block 1150.

At block 1150, either the pre-check or the post-check identified an issue and an error handler may be performed to perform appropriate logging and/or generate appropriate notifications and/or alerts, for example, via a user interface (e.g., user interface 110 or 312).

### Example Pre- and Post-Check Processing

FIG. 12 is a flow diagram illustrating a set of operations for performing a pre-check and/or a post-check in accordance with an embodiment of the present disclosure.

At block 1210, the discovery process for all subjects related to the parent key roll process are executed and the resulting inventory information and facts from the discovery processes are stored in a separate file.

At block 1220, a comparative analysis is performed on the inventory information and facts from this file and with the version of inventory information and facts stored in the inventory database for the discovery processes of these subjects related to the parent key roll.

At decision block 1230, the results of the comparative analysis are used to determine if the inventory information and facts from block 1210 matches the previously stored inventory information and facts from block 1220. A go decision is made when the results match and a no-go decision is made when they do not.

At block 1240, the go-no-go value is returned to the parent key roll process.

### Example Cryptographic Material Exchange

FIG. 13 is a flow diagram illustrating a set of operations for performing a cryptographic material exchange in accordance with an embodiment of the present disclosure. The process described with reference to FIG. 13 may be performed or coordinated by a server (e.g., command post server 220 or 330), for example, associated with a cryptographic management system delivered in accordance with a SaaS-based delivery model.

At block 1310, using parameter information retrieved from an inventory database (e.g., database 150 or inventory database 316), new cryptographic material is created.

At decision block 1320, it is determined whether the old material being replaced represents a data key. If so, processing continues with block 1330; otherwise, processing branches to block 1350.

At block 1330, the cryptographic material used to create the target ciphertext is used to convert to plaintext.

At block 1340, the plaintext is converted back to ciphertext using the new cryptographic material created at block 1310.

At block 1350, using parameters from the inventory database, new certificate material is stored correctly for the process that is serving the certificate at issue. The process is then restarted to effect the change of the new certificate material.

While in the context of explaining various examples with reference to particular flow diagrams, a number of enumerated blocks are included, it is to be understood that examples may include additional blocks before, after, and/or in between the enumerated blocks. Similarly, in some examples, one or more of the enumerated blocks may be omitted and/or performed in a different order.

### Example Computer System

Embodiments of the present disclosure include various steps, which have been described above. The steps may be performed by hardware components or may be embodied in machine-executable instructions, which may be used to cause a processing resource (e.g., a general-purpose or special-purpose processor) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors within a single computer) and storage systems containing or having network access to computer program(s) coded in accordance with various methods described herein, and the method steps associated with embodiments of the present disclosure may be accomplished by modules, routines, subroutines, or subparts of a computer program product.

FIG. 14 is a block diagram that illustrates a computer system 1400 in which or with which an embodiment of the present disclosure may be implemented. Computer system 1400 may be representative of all or a portion of the computing resources of a server (e.g., the command post server depicted in FIG. 1) of a SaaS platform and/or infrastructure on which a reconnaissance agent (e.g., recon agent 230, agent 162 or 172, or 410) or a sub-process thereof runs within a target environment. Notably, components of computer system 1400 described herein are meant only to exemplify various possibilities. In no way should example computer system 1400 limit the scope of the present disclosure. In the context of the present example, computer system 1400 includes a bus 1402 or other communication mechanism for communicating information, and a processing resource (e.g., a hardware processor 1404) coupled with bus 1402 for processing information. Hardware processor 1404 may be, for example, a general purpose microprocessor.

Computer system 1400 also includes a main memory 1406, such as a random access memory (RAM) or other dynamic storage device, coupled to bus 1402 for storing information and instructions to be executed by processor 1404. Main memory 1406 also may be used for storing temporary variables or other intermediate information during execution of instructions to be executed by processor 1404. Such instructions, when stored in non-transitory storage media accessible to processor 1404, render computer system 1400 into a special-purpose machine that is customized to perform the operations specified in the instructions.

Computer system 1400 further includes a read only memory (ROM) 1408 or other static storage device coupled to bus 1402 for storing static information and instructions for processor 1404. A storage device 1410, e.g., a magnetic disk, optical disk or flash disk (made of flash memory chips), is provided and coupled to bus 1402 for storing information and instructions.

Computer system 1400 may be coupled via bus 1402 to a display 1412, e.g., a cathode ray tube (CRT), Liquid Crystal Display (LCD), Organic Light-Emitting Diode Display (OLED), Digital Light Processing Display (DLP) or the like, for displaying information to a computer user. An input device 1414, including alphanumeric and other keys, is coupled to bus 1402 for communicating information and command selections to processor 1404. Another type of user input device is cursor control 1416, such as a mouse, a trackball, a trackpad, or cursor direction keys for communicating direction information and command selections to processor 1404 and for controlling cursor movement on display 1412. This input device typically has two degrees of freedom in two axes, a first axis (e.g., x) and a second axis (e.g., y), that allows the device to specify positions in a plane.

Removable storage media 1440 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 1400 may implement the techniques described herein using customized hard-wired logic, one or more ASICs or FPGAs, firmware or program logic which in combination with the computer system causes or programs computer system 1400 to be a special-purpose machine. According to one embodiment, the techniques herein are performed by computer system 1400 in response to processor 1404 executing one or more sequences of one or more instructions contained in main memory 1406. Such instructions may be read into main memory 1406 from another storage medium, such as storage device 1410. Execution of the sequences of instructions contained in main memory 1406 causes processor 1404 to perform the process steps described herein. In alternative embodiments, hard-wired circuitry may be used in place of or in combination with software instructions.

The term “storage media” as used herein refers to any non-transitory media that store data or instructions that cause a machine to operate in a specific fashion. Such storage media may comprise non-volatile media or volatile media. Non-volatile media includes, for example, optical, magnetic or flash disks, such as storage device 1410. Volatile media includes dynamic memory, such as main memory 1406. Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1402. Transmission media can also take the form of acoustic or light waves, such as those generated during radio-wave and infra-red data communications.

Various forms of media may be involved in carrying one or more sequences of one or more instructions to processor 1404 for execution. For example, the instructions may initially be carried on a magnetic disk or solid state drive of a remote computer. The remote computer can load the instructions into its dynamic memory and send the instructions over a telephone line using a modem. A modem local to computer system 1400 can receive the data on the telephone line and use an infra-red transmitter to convert the data to an infra-red signal. An infra-red detector can receive the data carried in the infra-red signal and appropriate circuitry can place the data on bus 1402. Bus 1402 carries the data to main memory 1406, from which processor 1404 retrieves and executes the instructions. The instructions received by main memory 1406 may optionally be stored on storage device 1410 either before or after execution by processor 1404.

Computer system 1400 also includes a communication interface 1418 coupled to bus 1402. Communication interface 1418 provides a two-way data communication coupling to a network link 1420 that is connected to a local network 1422. For example, communication interface 1418 may be an integrated services digital network (ISDN) card, cable modem, satellite modem, or a modem to provide a data communication connection to a corresponding type of telephone line. As another example, communication interface 1418 may be a local area network (LAN) card to provide a data communication connection to a compatible LAN. Wireless links may also be implemented. In any such implementation, communication interface 1418 sends and receives electrical, electromagnetic or optical signals that carry digital data streams representing various types of information.

Network link 1420 typically provides data communication through one or more networks to other data devices. For example, network link 1420 may provide a connection through local network 1422 to a host computer 1424 or to data equipment operated by an Internet Service Provider (ISP) 1426. ISP 1426 in turn provides data communication services through the worldwide packet data communication network now commonly referred to as the “Internet” 1428. Local network 1422 and Internet 1428 both use electrical, electromagnetic or optical signals that carry digital data streams. The signals through the various networks and the signals on network link 1420 and through communication interface 1418, which carry the digital data to and from computer system 1400, are example forms of transmission media.

Computer system 1400 can send messages and receive data, including program code, through the network(s), network link 1420 and communication interface 1418. In the Internet example, a server 1430 might transmit a requested code for an application program through Internet 1428, ISP 1426, local network 1422 and communication interface 1418. The received code may be executed by processor 1404 as it is received, or stored in storage device 1410, or other non-volatile storage for later execution.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein.

Some embodiments pertain to Example 1 that includes a method comprising: discovering cryptographic resources within one or more of a private datacenter, a colocation facility, and a public cloud, wherein the cryptographic resources include a plurality of assets and respective cryptographic material used by the plurality of assets; determining or inferring respective relationships among the plurality of cryptographic resources; and based on the cryptographic resources and the respective relationships, create or update a cryptographic inventory in a form of a semantic network that may be used to facilitate cryptoperiod reduction by enabling automated performance of a cryptographic action involving a plurality of the cryptographic resources, wherein nodes of the semantic network represent the cryptographic resources and edges of the semantic network represent the respective relationships.

Example 2 includes the subject matter of Example 1, wherein a relationship between a given pair of the plurality of assets includes information indicative of a role of each asset of the given pair as a data presenter or a data consumer.

Example 3 includes the subject matter of Example 1 or 2, wherein the cryptographic inventory includes information indicative of a provisioning source for the respective cryptographic material.

Example 4 includes the subject matter of any of Examples 1-3, wherein said discovering comprises one or more of (i) file system discovery, including crawling file systems mounted on operating system hosts of a first target environment and (ii) application programming interface (API) discovery, including interrogating one or more APIs exposed by one or more internal services of a cloud service provider representing a second target environment or one or more services provided via the cloud service provider.

Example 5 includes the subject matter of Example 4, wherein said determining or inferring respective relationships comprises correlating results of the file system discovery and API discovery.

Example 6 includes the subject matter of any of Examples 1-5, further comprising identifying a security risk based on the cryptographic inventory.

Example 7 includes the subject matter of any of Examples 1-6, further comprising mitigating the security risk by performing a cryptographic action based on the cryptographic inventory.

Some embodiments pertain to Example 8 that includes a method comprising: creating or updating a cryptographic inventory by discovering a plurality of assets and respective cryptographic material used by each of the plurality of assets, wherein the cryptographic inventory includes a mapping between the plurality of assets and the respective cryptographic material; and identifying a security risk based on the cryptographic inventory.

Example 9 includes the subject matter of Example 8, further comprising mitigating the security risk by performing a cryptographic action based on the cryptographic inventory.

Example 10 includes the subject matter of Example 8 or 9, wherein the cryptographic inventory includes, for each asset of the plurality of assets, information regarding inter-communication between or among the asset and one or more other assets of the plurality of assets.

Example 11 includes the subject matter of any of Examples 8-10, wherein said discovering further comprises causing an agent to crawl file systems mounted on one or more operating systems by deploying the agent within the one or more operating systems.

Example 12 includes the subject matter of any of Examples 8-11, wherein said discovering further comprises interrogating one or more application programming interfaces (APIs) exposed by a first cloud service provider or by one or more internal services of the first cloud service provider.

Example 13 includes the subject matter of Example 12, wherein said discovering further comprises interrogating one or more APIs exposed by a second cloud service provider or by one or more internal services of the second cloud service provider.

Example 14 includes the subject matter of any of Examples 8-13, further comprising discovering cryptographic material present within a hardware security module or a key management system (KMS) associated with a target environment.

Example 15 includes the subject matter of any of Examples 8-14, further comprising identifying usage purposes of cryptographic keys of the respective cryptographic material.

Example 16 includes the subject matter of any of Examples 8-15, wherein the security risk comprises cryptographic key reuse by two or more assets of the plurality of assets or use of a compromised cryptographic key by an asset of the plurality of assets.

Example 17 includes the subject matter of Example 16, wherein the cryptographic action comprises evaluation of rule-based conditions that identify one or more assets of the plurality of assets as a subject for key roll.

Some embodiments pertain to Example 18 that includes a system comprising: one or more processing resources; and instructions that when executed by the one or more processing resources cause the system to: create or update a cryptographic inventory by discovering a plurality of assets and respective cryptographic material used by each of the plurality of assets, wherein the cryptographic inventory includes a mapping between the plurality of assets and the respective cryptographic material; identify a security risk based on the cryptographic inventory; and mitigate the security risk by performing a cryptographic action based on the cryptographic inventory.

Example 19 includes the subject matter of Example 18, wherein the cryptographic inventory includes, for each asset of the plurality of assets, information regarding inter-communication between or among the asset and one or more other assets of the plurality of assets.

Example 20 includes the subject matter of Example 18 or 19, wherein discovery of the plurality of assets and respective cryptographic material includes causing an agent to crawl file systems mounted on one or more operating systems by deploying the agent within the operating systems.

Example 21 includes the subject matter of any of Examples 18-20, wherein discovery of the plurality of assets and respective cryptographic material includes interrogating one or more application programming interfaces (APIs) exposed by one or more cloud service providers or by one or more internal services of the one or more cloud service providers.

Example 22 includes the subject matter of any of Examples 18-21, wherein discovery of the plurality of assets and respective cryptographic material includes discovering cryptographic material present within a hardware security module or a key management system (KMS) associated with a target environment.

Example 23 includes the subject matter of any of Examples 18-22, wherein the instructions further cause the system to identify usage purposes of cryptographic keys of the respective cryptographic material.

Some embodiments pertain to Example 24 that includes a non-transitory machine readable medium storing instructions, which when executed by one or more processing resources of a cryptographic management system, cause the cryptographic management system to: create or update a cryptographic inventory by discovering a plurality of assets and respective cryptographic material used by each of the plurality of assets, wherein the cryptographic inventory includes a mapping between the plurality of assets and the respective cryptographic material; identify a security risk based on the cryptographic inventory; and mitigate the security risk by performing a cryptographic action based on the cryptographic inventory.

Example 25 includes the subject matter of Example 24, wherein the cryptographic inventory includes, for each asset of the plurality of assets, information regarding inter-communication between or among the asset and one or more other assets of the plurality of assets.

Example 26 includes the subject matter of Example 24 or 25, wherein discovery of the plurality of assets and respective cryptographic material includes causing an agent to crawl file systems mounted on one or more operating systems by deploying the agent within the operating systems.

Example 27 includes the subject matter of any of Examples 24-26, wherein discovery of the plurality of assets and respective cryptographic material includes interrogating one or more application programming interfaces (APIs) exposed by one or more cloud service providers or by one or more internal services of the one or more cloud service providers.

Example 28 includes the subject matter of any of Examples 18-27, wherein discovery of the plurality of assets and respective cryptographic material includes discovering cryptographic material present within a hardware security module or a key management system (KMS) associated with a target environment.

Example 29 includes the subject matter of any of Examples 18-28, wherein the instructions further cause the system to identify usage purposes of cryptographic keys of the respective cryptographic material.

Some embodiments pertain to Example 30 that includes an apparatus or system that implements or performs a method of any of Examples 1-7.

Some embodiments pertain to Example 31 that includes an apparatus or system that implements or performs a method of any of Examples 8-17.

Some embodiments pertain to Example 32 that includes at least one machine-readable medium comprising a plurality of instructions, that when executed on a computing device, implement or perform a method or realize an apparatus as described in any preceding Example.

Example 33 includes an apparatus or system comprising means for performing a method as claimed in any of Examples 1-7.

Example 34 includes an apparatus or system comprising means for performing a method as claimed in any of Examples 8-17.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
discovering cryptographic resources within one or more of a private datacenter, a colocation facility, and a public cloud, wherein the cryptographic resources include a plurality of assets and respective cryptographic material used by the plurality of assets;
determining or inferring respective relationships among the plurality of cryptographic resources; and
based on the cryptographic resources and the respective relationships, create or update a cryptographic inventory in a form of a semantic network that may be used to facilitate cryptoperiod reduction by enabling automated performance of a cryptographic action involving a plurality of the cryptographic resources, wherein nodes of the semantic network represent the cryptographic resources and edges of the semantic network represent the respective relationships.

2. The method of claim 1, wherein a relationship between a given pair of the plurality of assets includes information indicative of a role of each asset of the given pair as a data presenter or a data consumer.

3. The method of claim 1, wherein the cryptographic inventory includes information indicative of a provisioning source for the respective cryptographic material.

4. The method of claim 1, wherein said discovering comprises one or more of (i) file system discovery, including crawling file systems mounted on operating system hosts of a first target environment and (ii) application programming interface (API) discovery, including interrogating one or more APIs exposed by one or more internal services of a cloud service provider representing a second target environment or one or more services provided via the cloud service provider.

5. The method of claim 4, wherein said determining or inferring respective relationships comprises correlating results of the file system discovery and API discovery.

6. A method comprising:
creating or updating a cryptographic inventory by discovering a plurality of assets and respective cryptographic material used by each of the plurality of assets, wherein the cryptographic inventory includes a mapping between the plurality of assets and the respective cryptographic material;
identifying a security risk based on the cryptographic inventory; and
mitigating the security risk by performing a cryptographic action based on the cryptographic inventory.

7. The method of claim 6, wherein the cryptographic inventory includes, for each asset of the plurality of assets, information regarding inter-communication between or among the asset and one or more other assets of the plurality of assets.

8. The method of claim 6, wherein said discovering further comprises causing an agent to crawl file systems mounted on one or more operating systems by deploying the agent within the one or more operating systems.

9. The method of claim 6, wherein said discovering further comprises interrogating one or more application programming interfaces (APIs) exposed by a first cloud service provider or by one or more internal services of the first cloud service provider.

10. The method of claim 9, wherein said discovering further comprises interrogating one or more APIs exposed by a second cloud service provider or by one or more internal services of the second cloud service provider.

11. The method of claim 6, further comprising discovering cryptographic material present within a hardware security module or a key management system (KMS) associated with a target environment.

12. The method of claim 6, further comprising identifying usage purposes of cryptographic keys of the respective cryptographic material.

13. The method of claim 6, wherein the security risk comprises cryptographic key reuse by two or more assets of the plurality of assets or use of a compromised cryptographic key by an asset of the plurality of assets.

14. The method of claim 13, wherein the cryptographic action comprises evaluation of rule-based conditions that identify one or more assets of the plurality of assets as a subject for key roll.

15. A system comprising:
one or more processing resources; and
instructions that when executed by the one or more processing resources cause the system to:
create or update a cryptographic inventory by discovering a plurality of assets and respective cryptographic material used by each of the plurality of assets, wherein the cryptographic inventory includes a mapping between the plurality of assets and the respective cryptographic material;
identify a security risk based on the cryptographic inventory; and
mitigate the security risk by performing a cryptographic action based on the cryptographic inventory.

16. The system of claim 15, wherein the cryptographic inventory includes, for each asset of the plurality of assets, information regarding inter-communication between or among the asset and one or more other assets of the plurality of assets.

17. The system of claim 16, wherein discovery of the plurality of assets and respective cryptographic material includes causing an agent to crawl file systems mounted on one or more operating systems by deploying the agent within the operating systems.

18. The system of claim 16, wherein discovery of the plurality of assets and respective cryptographic material includes interrogating one or more application programming interfaces (APIs) exposed by one or more cloud service providers or by one or more internal services of the one or more cloud service providers.

19. The system of claim 16, wherein discovery of the plurality of assets and respective cryptographic material includes discovering cryptographic material present within a hardware security module or a key management system (KMS) associated with a target environment.

20. The system of claim 16, wherein the instructions further cause the system to identify usage purposes of cryptographic keys of the respective cryptographic material.
